(19) United States
(12) Patent Application Publication
(10) Pub. No.: US 2012/0102383 A1
(43) Pub. Date: Apr. 26, 2012

(54) Creating, Sharing and Modifying Documents That Include Content and an Integrated Software Application

(76) Inventor: Jerald Liu, Long Valley, NJ (US)

(21) Appl. No.: 13/166,177

(22) Filed: Jun. 22, 2011

Related U.S. Application Data
(60) Provisional application No. 61/405,193, filed on Oct. 20, 2010.

(51) Int. Cl. G06F 17/00

(52) U.S. Cl. 715/202

(57) ABSTRACT

An interactive user interface is operable to present screens to a user to facilitate creating or modifying an electronic document that comprises one or more content pages and an application page that includes an integrated software application related to content of the content page. The interactive user interface includes a content screen through which the user enters content for each content page of the document, and an application screen through which the user enters information related to the application page. The application screen is operable to provide a first view for the user to enter information specifying one or more of layout, input control, report control or plot control for a graphical user interface, and a second view for the user to enter core programming code for the software application.

### CROSS-REFERENCE TO RELATED APPLICATION(S)

This application claims the benefit of priority of U.S. Provisional Patent Application No. 61/405,193, filed on Oct. 20, 2010.

### BACKGROUND

Documents in various forms are useful to disseminate knowledge, but typically the documents are static. For example, the structure of the documents usually is based on the interests of the particular author(s) and generally cannot be changed by the reader. Furthermore, in some cases, a reader may be unable completely to grasp an idea or concept disclosed in the document because the idea or concept is not illustrated in an interactive manner.

Some Internet articles refer, for example, to a third-party web site that contains an interactive web application that may pertain to the concept. Sometimes, however, the application is not directly related to the context pertaining to the concept described in the Internet article. In such situations, the Internet article is not coherent with its linked web application.

Sometimes Internet articles include a software application within a specific context. However, the articles may not provide the reader the ability easily to modify or publish the content of the article or to publish additional findings after using the software application relevant to the reader's own specific context.

This disclosure addresses technical problems associated with the creation, hosting and rendering of documents that include content and an integrated software application. The disclosure also addresses technical problems associated with the sharing and modification of such documents.

### SUMMARY

Various aspects of the invention are set forth in the claims.

For example, according to one aspect, an apparatus includes an interactive user interface that presents screens to a user to facilitate creating or modifying an electronic document that comprises one or more content pages and an application page that includes an integrated software application related to content of the content page. The interactive user interface includes a content screen through which the user enters content for each content page of the document, and an application screen through which the user enters information related to the application page. The application screen is operable to provide a first view for the user to enter information specifying one or more of layout, input control, report control or plot control for a graphical user interface, and a second view for the user to enter core programming code for the software application.

The information and core programming code entered through the screens of the interactive user interface then can be used by to create the electronic document in which the application page presents the graphical user interface to allow a user to make entries in data fields appearing on the application page. The entries are used as input by the software application, which in response to receiving the input, returns output to be displayed on the application page.

Various implementations include one or more of the following features. For example, the application screen can be operable to provide a third view of an XML file that captures results of evaluating the software application. The application screen can be operable to allow a user to specify that the results of evaluating the software application are to be used as input to another software application to enable connectivity of multiple software applications in the document.

In some implementations, the interactive user interface is operable to cause information entered by the user through the content screen and the application screen to be stored in a network server system. The interactive user interface can include a screen through which the user can enter a table of contents for the document, wherein each page of the document is linked to a corresponding entry in the table of contents. The interactive user interface also can include a screen through which the user can indicate whether the document is to be a newly created document or a modification of a previously stored document. The interactive user interface can be operable to permit the user to upload information entered through the content screen and the application screen to a user account associated with the user. The interactive user interface can include a screen through which the user establishes access permissions that specify which, if any, of the content pages or the application page one or more third parties are permitted to access or modify. The interactive user interface also can include a screen that provides a peer networking tool for the user to exchange communications with a third party about creation or modification of the document.

According to another aspect, a system includes a server system operable to provide information to a user device. The information causes interactive screens to be displayed on the user device to facilitate a user's creating or modifying an electronic document that comprises one or more content pages and an application page that includes an integrated software application related to the content of the content page. The interactive screens include a content screen and an application screen. Content for each content page of the document can be entered through the content screen. Information related to the application page can be entered through the application screen. The application screen is operable to provide a first view for the user to enter information specifying one or more of the layout, input control, report control or plot control for a graphical user interface, and a second view for the user to enter core programming code for the software application. The server system is operable to store information entered by the user through the content screen and the application screen. The information and core programming code entered through the interactive screens then can be used to create the electronic document.

Some implementations include one or more of the following features. For example, the document with the integrated software application can be stored at its own web site on the Internet, and each page of the document can be implemented as a web page. The document with the integrated software application can be hosted on the server system and can be accessible via the Internet.

In some implementations, the interactive screens include a screen that provides a peer networking tool for the user to exchange communications with a third party about creation or modification of the document. The server system can include a user account system to facilitate sharing of the document with other users and is operable to facilitate active sharing of the document through peer networking technology including server and client embedded systems. The server system can be operable to allow presentation of the document such that a presenter's navigating to a different page of the document or submitting a value for the data fields of the software application for execution is reflected automatically to a member of an audience. The server system also can be operable to allow a member of the audience to navigate through a document being presented without affecting an on-going presentation and without being reflected on other users' devices.

In other aspects, methods for facilitating the creation or modification of an electronic document are disclosed. In addition, articles comprising a machine-readable medium that store instructions for facilitating the creation or modification of an electronic document are disclosed.

In another aspect, a system includes a server system with one or more servers to manage and host a library of documents that is accessible from a user device via one or more network web sites. Each document includes content and an integrated software application, and each software application is operable to receive one or more user-modifiable input values entered in one or more data fields displayed on the user device. A database stores user data for the software applications, and a cloud computing platform performs computations requested by the software applications. The software applications are operable to provide output based on the received input values for display on the user device.

In some implementations, the system includes multiple user devices coupled to the server system via a computer network. The user devices are operable for actively sharing a particular document from the library such that a first user's actions with respect to the particular document are automatically displayed on respective devices of other users. The first user's actions can include, for example, navigating to a different page of the particular document or submitting for execution values for the data fields of the particular document's software application. The devices of the other users can be operable to allow a respective user to navigate through a document being presented by the first user without affecting the on-going presentation and without being reflected on other users' devices.

In some implementations, multiple documents are interrelated such that output from the integrated software application of a first one of the documents is provided automatically as input for the integrated software application of a second one of the documents.

Various implementations thus address the technical problems associated with the creation, hosting and rendering of documents that include content and an integrated software application. Various implementations also address the technical problems associated with the sharing and modification of such documents.

Other aspects, features and advantages will be apparent from the following detailed description, the accompanying drawing and the claims.

### BRIEF DESCRIPTION OF THE DRAWINGS

FIG. 1 illustrates an example of a user interface including a content page of a document.

FIG. 2 illustrates an example of an application page of the document.

FIG. 3 is a block diagram illustrating an example of a system according to the invention.

FIGS. 4-10 are examples of screenshots that are presented as part of an interactive user interface to allow a user to provide information for creating a document with an integrated software application.

FIG. 11 is an example of a screenshot of a consumer survey that incorporates methodologies from multiple documents.

### DETAILED DESCRIPTION

The system described below provides an interactive user interface that facilitates the creation, sharing and modification of electronic documents that include content together with an integrated software application for one or more interdependent topics. In some cases, the software application can be used to illustrate one or more aspects of a concept described by the content portion of the document. In a particular example, the content portion of the document describes a mathematical concept that can be implemented as a software algorithm. More generally, the content portion can describe any concept that can be implemented or modeled by a software algorithm using machine program code. The software application functions in conjunction with the content portion and serves to illustrate an example pertaining to a specific field of study. The content portion can include, for example, a description of context and a description of specific problems associated with a particular field of study. The content also can describe solutions to the problems given by the mathematical algorithm and the software applications. The content also may include a user's findings or conclusions.

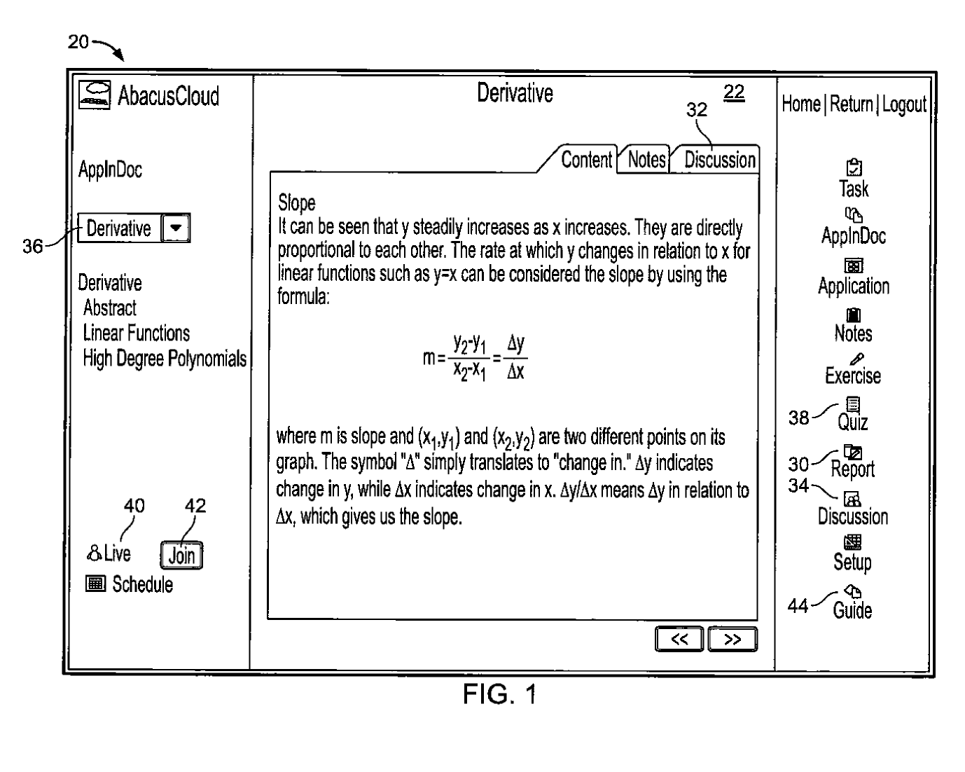

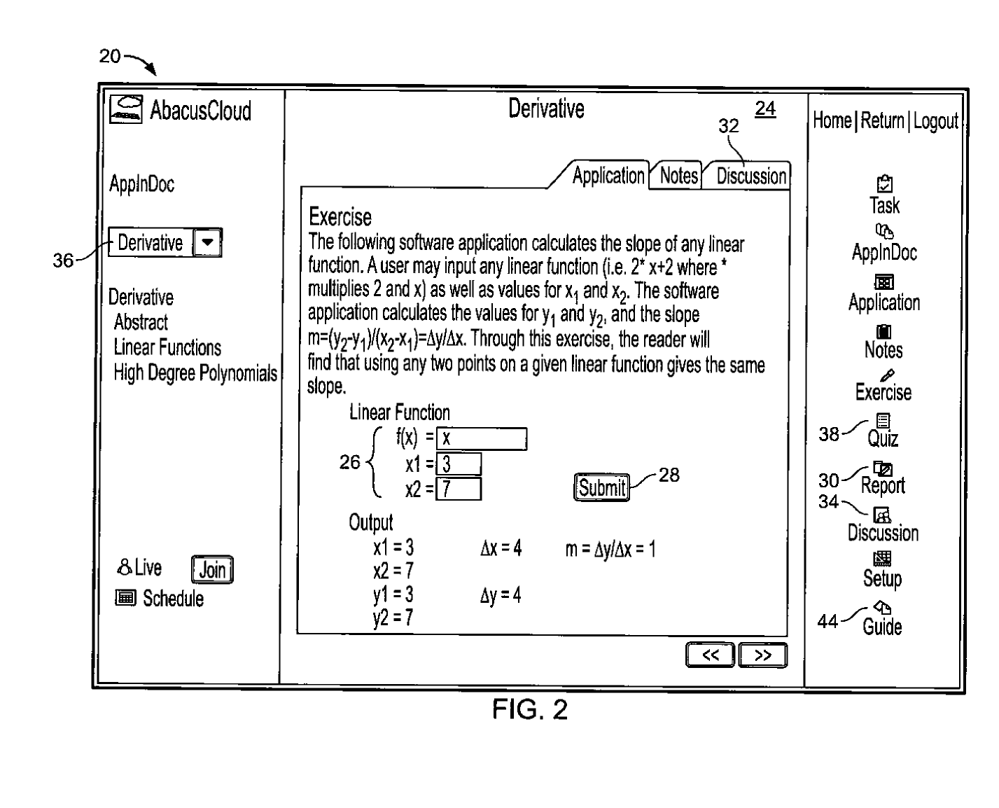

FIG. 1 is an example of a user interface that illustrates a content page 22 of a document 20. In this example, the content page 22 describes the mathematical definition for the slope of a linear function. FIG. 2 shows an example of an application page 24 of the document 20. In this example, the application page 24 can be used to calculate the slope of a user-specified linear function through an embedded software application, which, in this case, embodies and executes an algorithm for calculating the slope of the particular function. Core programming code implements the algorithm and can be hosted, for example, on a user media device with, e.g., Java scripts so that the algorithm is accessible to the document 20. The core programming code also can be hosted in an application service on the Internet such that individual servers with one or more CPUs can be used to carry out the required computations. For algorithms requiring intensive computations, the core programming code can be hosted in an application service in a cloud computing platform that utilizes clusters of servers with one or more CPUs through parallel processing. In either case, the application service can be accessible not only for the document 20, but also to other documents that utilize the algorithm.

The application page 24 illustrated in FIG. 2 provides default values within data fields 26 that can be changed by a user. The user can enter values in the data fields 26 using, for example, a keyboard or other user input device. The user can submit the values entered in the data fields 26 by selecting the submit button 28 using, for example, an electronic mouse or other user input device. Upon submission of the values in the data fields 26, the software application executes the algorithm. Results can be displayed as output in the form of numerical or textual data, tables, graphics, animations, audio or video.

Depending on the particular example, the data fields 26 can contain various types of textual data (numbers, letters and symbols) organized such that it is compatible with the particular software application integrated into the document. For example, a document that teaches a programming language may contain a software application that evaluates programming code—organized textual data—provided by a user through data fields 26. Another form of organized textual data is a static document, such as html, Word, Excel or PDF format. Other organized textual data can include telephone numbers, dates, words or mathematical expressions.

The software application can contain its own description or instruction. Labels can be provided in the document to identify the data fields 26. Presentation of the solution (i.e., the output of the algorithm) can be provided as part of the document's context. Therefore, the format of the document's solution can be modified for integration with the document's context. In some cases, a software application can be used in multiple contexts in the document 20. The description or instruction, as well as labels to data fields 26, can be customized for the specific context in question. A software application can have multiple modifiable interactive user interfaces to accommodate different formats or different user media devices for presentation of the document 20. For a single document, or multiple documents with related algorithms, multiple software applications can be dependent such that one software application relies not only on user input for data fields 26, but also on the results of one or more other software applications.

In various implementations, the content portion of the document 20 may be either mathematically-oriented or context-oriented. The content portion of a mathematically-oriented document, for example, can focus on an underlying mathematical concept of a logical algorithm and its accompanying software application. Various subject areas may provide the context within which the mathematical concept is applied. Any mathematical concept or approximate mathematical concept that can be described through a logical algorithm can be the subject area of a mathematically-oriented document 20. For some complex logical algorithms, more than one software application may be created for the document 20 such that they provide complete solutions to the logical algorithm.

The following example illustrates some of these features. The process of finding the derivative of any given function is the logical algorithm of a mathematically-oriented document 20 that explains how to calculate the derivative of any given function. One data field 26 (see FIG. 2) may contain, for example, a function and another data field may contain a specific point at which a user wants to find the derivative of the designated function. In this example, both data fields 26 are necessary for the calculation. After a user enters a function or a point in the respective input field 26, the user can submit the information using the Submit button 28. In response, the software application calculates the derivative of the function at the specified point and provides as an output the derivative of the function at the specified point.

In contrast, the content portion of a context-orientated document 20 focuses on one or more problems in a specific subject field. One or more logical algorithms, accompanied by appropriate software applications, are used to obtain solutions to the problems. For example, the subject area of derivatives explained in the mathematically-oriented document 20 described in the previous example can be applied to the field of motion physics where, in relation to time, velocity is the derivative of position, and acceleration is the derivative of velocity. The software application in the mathematically-oriented document in the previous example can be used in a context-oriented document by making any needed modifications to the software application to make it a cohesive entity in the respective context-oriented document. The software application of a context-oriented document that addresses, for example, motion physics (e.g., the components of position, velocity and acceleration), can compute derivatives the same way in which the mathematically-oriented document computes derivatives. However, the data fields 26 containing input and output values or messages may be different. For example, the software application in a context-oriented document that applies derivatives to the field of motion physics may assess a user's knowledge in different ways and may, therefore, employ data fields that contain components different from those in the mathematically-oriented document. On the other hand, the same logical algorithm that underlies the software application that calculates derivatives in the mathematically-oriented document can be used. Thus, the software application in a mathematically-oriented may be used for a context-oriented document as well. In this case, however, the description and labels of the software application 103 can be customized for the particular context-oriented document.

The document 20 can be implemented, for example, using World Wide Web technology. In the illustrated implementation, each document 20 is stored at its own web site on the Internet, and each page of the document 20 is implemented as a web page.

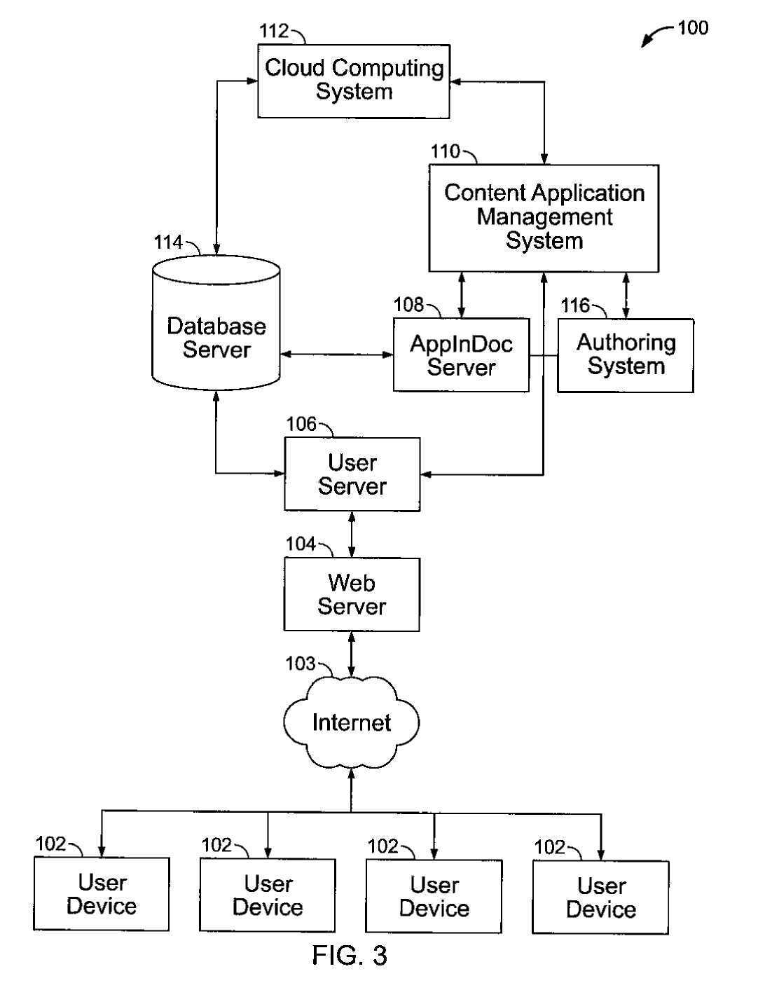

FIG. 3 illustrates an example of a computer server system 100 that provides a database and software tools to integrate various interrelated documents such as the document 20 described above. The system 100 includes computer networks with hardware and software architectures that provide tools to facilitate the creation, hosting and rendering of documents 20. The system 100 also provides functions for social networking, webcasting, and storing data related to the created and stored documents.

Users can access the system 100 through user media devices 102 via wired or wireless connections to a web server 104 through the Internet or other network 103. Examples of user media devices 102 include computers, interactive televisions, e-books, kiosks, tablets, smart phones, media players, and motion and touch sensory interfaces. To provide for interaction with a user, the device 102 can have a display for displaying information to the user and a user input device (e.g., a keyboard, a mouse, a trackball, or a touch screen), which allows the user to provide input to the device (e.g., enter data, make selections).

As shown in the example of FIG. 3, a user server 106 provides the basic functionality of a user account and a library of documents 20 or professional or business software systems. Another server (“ApplnDocServer”) 108 renders the documents 20 for various types of user media devices 102. This server 108 also provides active peer networking for the interactive presentation of documents 20 or professional or business software systems. For example, the server 108 can facilitate instant messaging type services. The AppInDoc Server 108 interacts with another server (“Content-Application Management System Server”) 110 that manages and hosts documents 20 or professional or business software systems. A cloud computing system 112 performs computations requested by software applications hosted in the Content-Application Management System Server 110. A user database server 114 stores user data for, and received from, software applications that are accessible through documents 20 or professional or business software systems. An authoring system 116, described in greater detail below, provides the functionality that allows users to create, modify and publish documents 20 or professional or business software systems. Although separate servers are illustrated in FIG. 3, in some implementations, some or all of the servers can be integrated into a single server. The server system can be accessed from the user devices 102, for example, through an Internet web site. Users may be required to enter account, identification and/or password information.

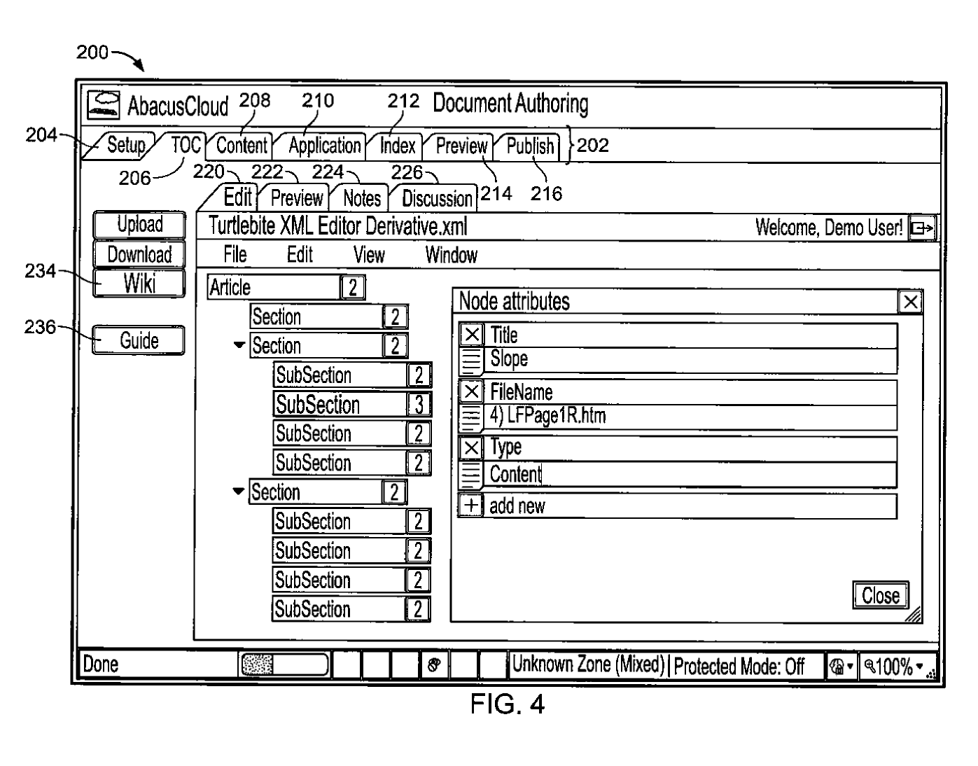

Aspects of the workflow and functionality of the authoring system 116 are illustrated with respect to the screenshots of FIGS. 4 through 10. The screenshots can be displayed on a user device such as device 102. In FIG. 4, a tab menu strip 202 near the top of screen 200 represents the overall workflow for authoring a document 20 according to the illustrated example. The illustrated screen includes a Setup tab 204, a table of contents (TOC) tab 206, a Content tab 208, an Application tab 210, an Index tab 212, a Preview tab 214 and a Publish tab 216. The functionality provided by the tabs 204 through 216 is described below.

The Setup tab 204 allows a user to identify whether he intends to create a new document 20 or modify an existing one. The user can enter information using a key to identify co-authors, if any, and choose the subject area, topic and title for the document. The user also can identify a publisher as well as a software application developer, if needed. The Setup tab 204 also allows the user to establish access permissions for the co-authors, publisher and developer, as well as other users. The access permissions specify what parts of a document 20 each entity is permitted to access or modify.

The TOC tab 206 allows the user to create or modify a table of contents for the document. For example, using an Edit tab 220, the user can enter information such as title, authorship and document identification. In addition, The TOC tab 206 allows the user to enter page information for type (i.e., content or application) and file names for the cover, abstract, sections and subsections. The table of contents can be implemented, for example, by an XML file. The user can upload the table of contents file to his user account if it already exists on the user's device 102. If the user is modifying an existing document 20, the user also can download the table of contents file of the existing document from the ApplnDoc server 108 to the user's account. As shown by the Wiki item 234 in the menu on the left-hand side of the screen 200 in FIG. 4, a Wiki editor (e.g., TurtleBite) can be used to create or edit the table of contents file in the user's account. The table of contents can be previewed by selecting a Preview tab 222. The user can take notes using a Notes tab 224 and can discuss matters related to the table of contents with the co-authors or publisher by selecting a Discussion tab 226. A Guide item 236 at the bottom of the menu provides detailed guidance about the TOC tab 206 to the user.

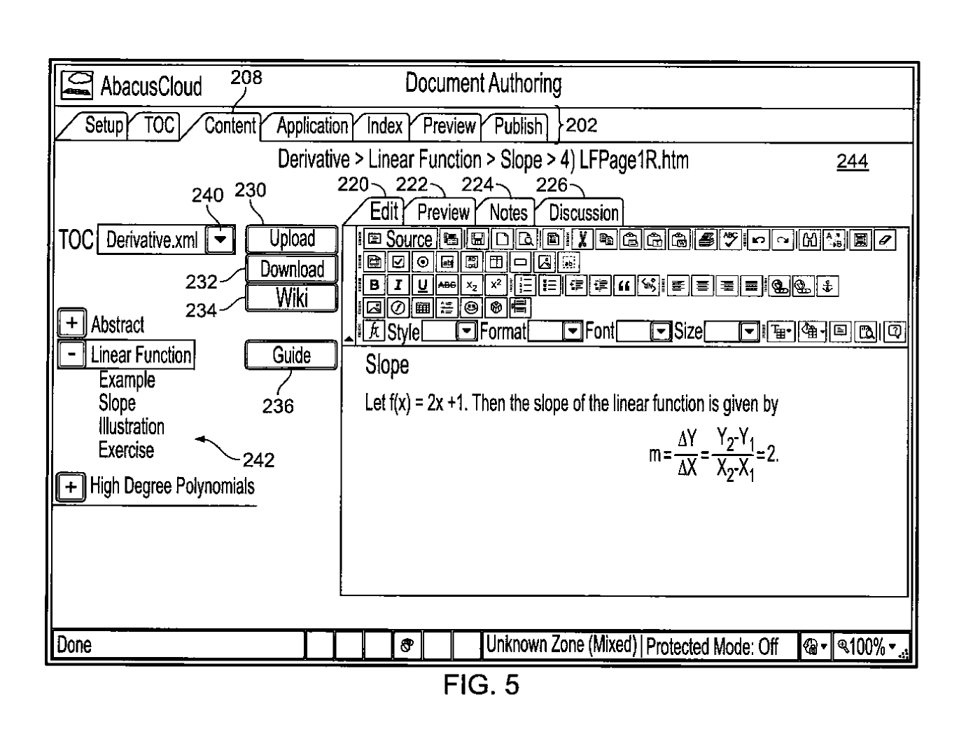

The Content tab 208 allows the user to enter the content for each content page designated by the table of contents. Each page is linked to a corresponding entry in the table of contents. As illustrated in the screenshot of FIG. 5, a list 242 under a drop-down menu 240 on the left-hand side indicates that the “Slope” page for calculating a derivative (see FIG. 1) is selected for editing. In this example, at the top of the content area 244, the document title, section and subsection titles, as well as the file name, are displayed. The user can upload the “Slope” page from his user device 102 to his user account by selecting an Upload tab 230. For example, the content page can be created or edited on the user's laptop computer using Microsoft Word, which provides functions for including text as well as mathematical formulae. Also, using a download tab 232, the user can download a content page from the AppInDoc server 108 if the new document is to be a modification of an existing one. By selecting the Wiki tab 234, the user can use the Wiki editor to create or edit the “Slope” page in the user's account. The Wiki editor allows the user to enter regular text as well as mathematical formulae. In the illustrated example, the FCK Editor with a CODECOGS LaTex plug-in is used. The page can be previewed by selecting the Preview tab 222. As before, the user can use the Notes tab 224 and the Discussion tab 226 to take notes or discuss issues with co-authors or with a publisher. For example, the FCK editor with CODECOGS can be used to take notes, and the Wiki editor can be used for discussions. In this view, the Guide menu item 236 provides detailed guidance to the user about the Content tab 208.

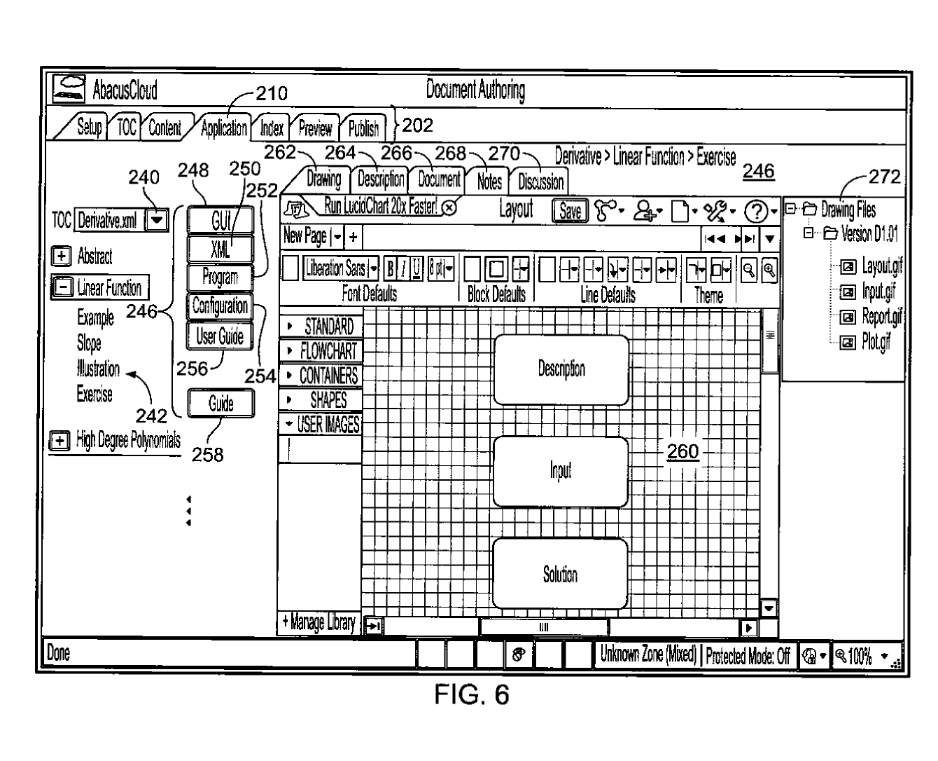

The Application tab 210 allows the user to create or edit application pages, such as the application page 24, for the document 20. FIGS. 6 through 10 illustrate various features accessible via the Application tab 210.

In the illustrated example of FIG. 6, the list 242 under a drop-down menu 240 on the left-hand side indicates that the “Exercise” page (see FIG. 2) is selected for editing. The top of the main work area 246 shows the document identification, section, and the subsection page for the application. A menu 246 includes the following items: GUI (graphical user interface) 248, XML 250, Programming 252, Configuration 254, User Guide 256, and Guide 258. These menu items are described in the following paragraphs.

FIG. 6 illustrates an example of the GUI view when the GUI menu item 248 and the Drawing tab 262 are selected. A Wiki drawing area 260 incorporates a tool (e.g., LucidChart) for creating the layout, input control, report control or plot control of the graphical user interface for the “Exercise” application page. As shown in FIG. 6, the drawing area can include a Description area 262A, an Input area 262B and a Solution area 262C. The information provided in these areas can correspond, respectively, for example, to the information that appears on the “Exercise” page illustrated in FIG. 2. The user can provide a description of the software application that describes to the reader how to use the software application. For example, the user can enter the description using the Description tab 264 and would be displayed, for example, as a small paragraph, such as that below the heading “Exercise” in FIG. 2. The user also can provide information that explains the details of the GUI for the software developer by selecting the Document tab 266. Notes can be entered by selecting the Notes tab 268 in the GUI view. The GUI view also allows discussion between author, co-authors and developer by selecting the Discussion tab 270. The right-hand side of the screenshot shows the graphical files 272 for GUIs created by the user.

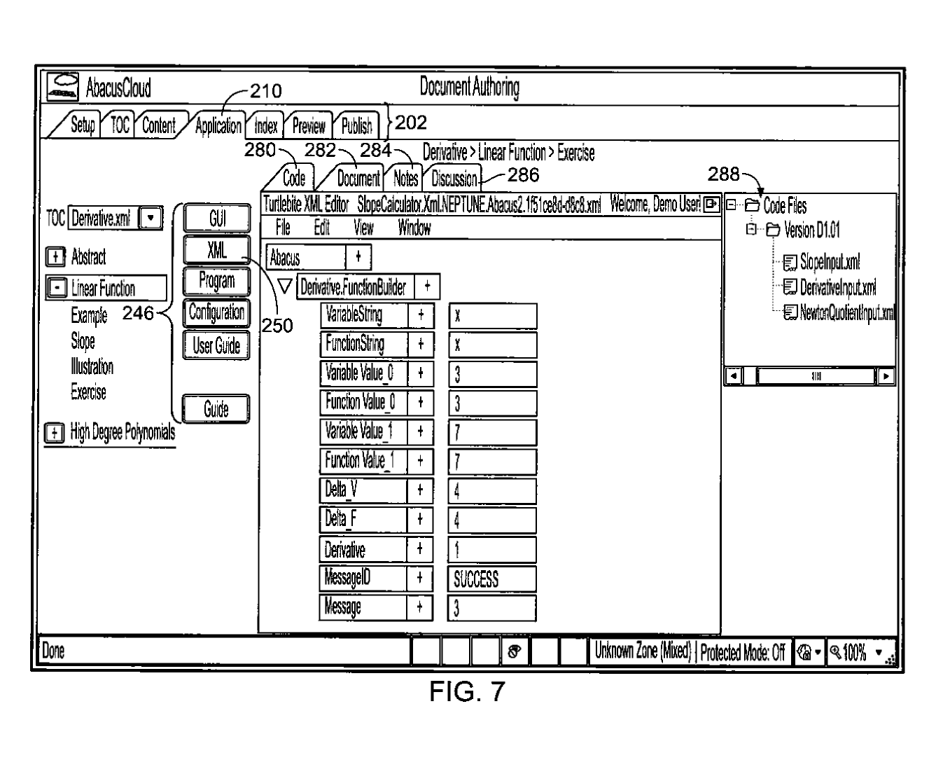

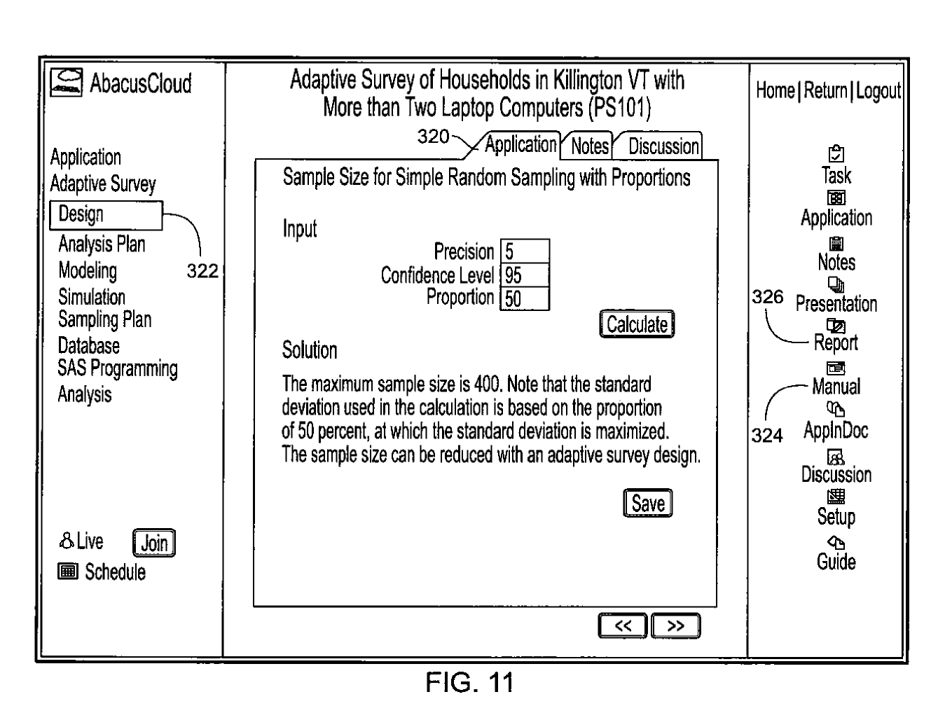

FIG. 7 illustrates an XML view for an application page of the document when the XML menu item 250 and the Code tab 280 are selected. An XML file captures the results of evaluating a software application. The results then can be used as input to another software application. This feature enables connectivity of multiple software applications for complex algorithms within a document 20 or for complex professional or business problem solutions within software systems embedded with multiple documents 20. An example is discussed below in connection with FIG. 11. A Wiki editor (e.g., Turtlebite) provides the user with a tool for creating XML schema for the Exercise application output. The user also can provide information that explains the details of the XML output for the software developer by selecting the Document tab 282. In the XML view, the user can enter notes by selecting the Notes tab 284. The XML view also allows discussion between author, co-authors and developer by selecting the Discussion tab 286. The right-hand side of the screenshot shows the XML files 288 created by the user.

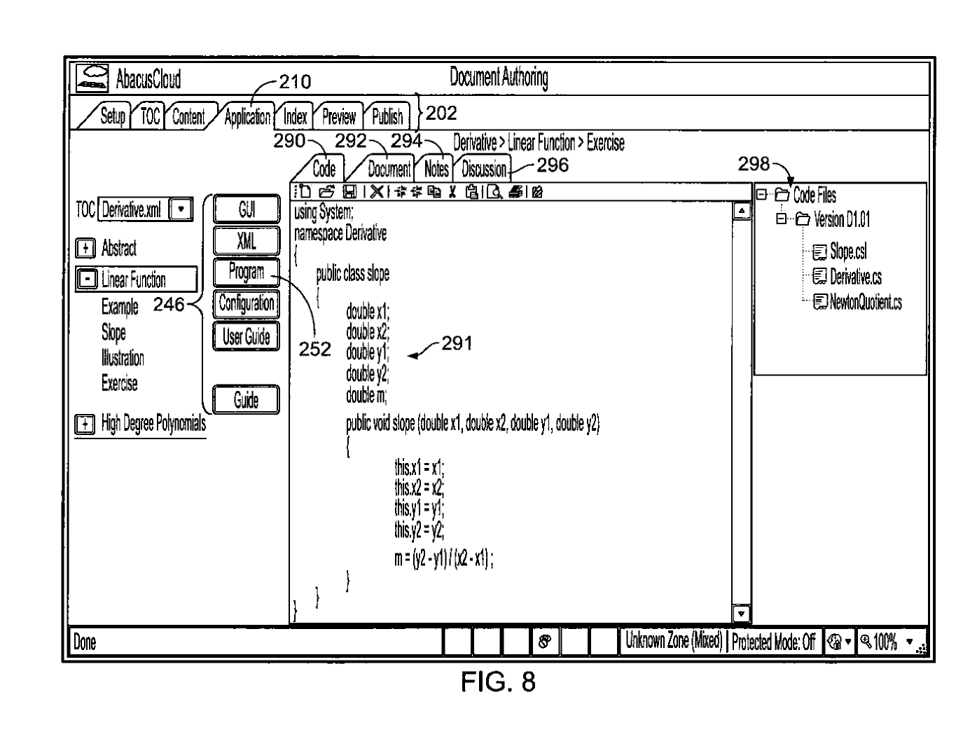

FIG. 8 illustrates a Program view for an application page of the document when the Program menu item 252 and the Code tab 290 are selected. The Wild editor provides the user with a tool for creating core programming code 291, for example, in C# for the “Slope” application of the “Exercise” application page. The user also can provide information that explains the details of the C# programs for the software developer by selecting the Document tab 292. The user can enter notes by selecting the Notes tab 294. The Programming view also allows discussions between author, co-authors and developer by selecting the Discussion tab 296. The right-hand side of the screenshot shows the C# files 298 created by the user.

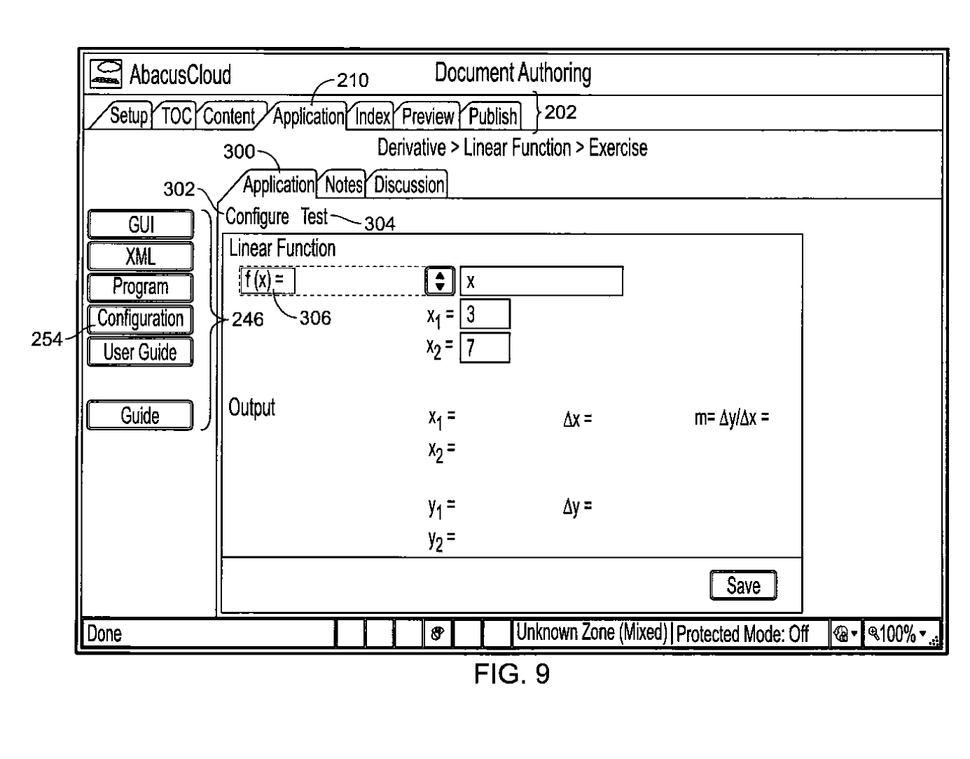

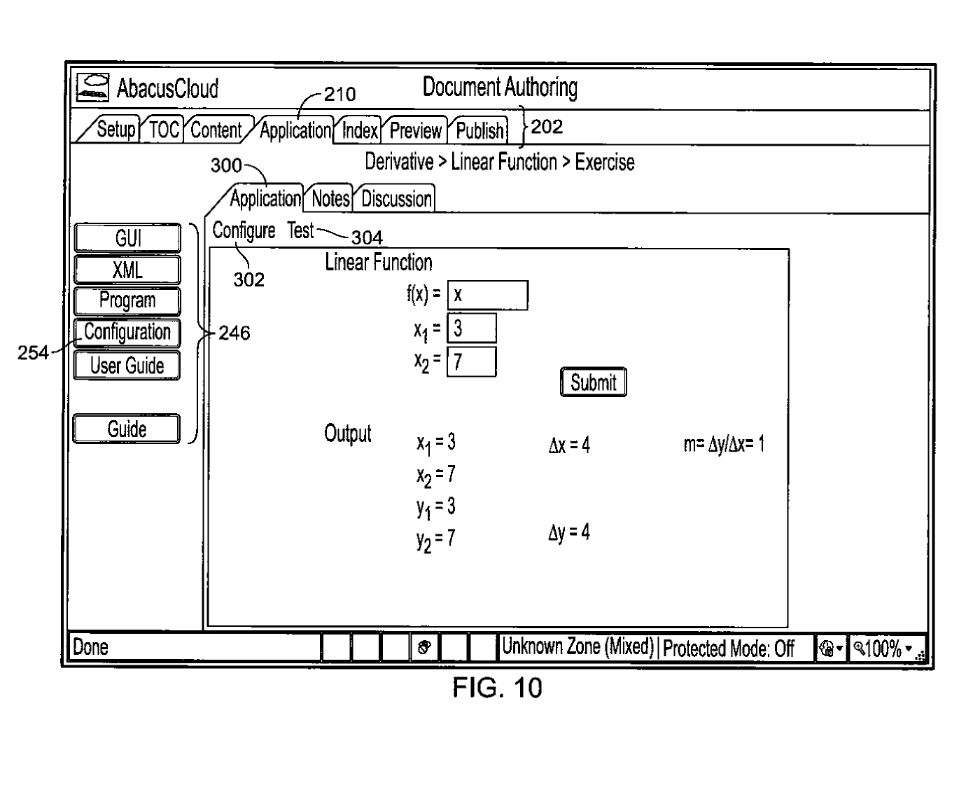

Configuration views of the software application can be accessed and displayed by selecting the Configuration menu item 254. As shown for example in FIG. 9, when the Application tab 300 and the Configure tab 302 are selected, a configuration page is displayed and allows the user to modify the GUI provided by the developer of the software application for integration with the content portion of the document 20. For example, the user may decide to use “f(x)” as the label 306 for the function input field. As shown in FIG. 10, when the Application tab 300 and Test tab 304 are selected, a test page is displayed and allows a user to preview the GUI and to evaluate the slope of the function in the input field at specified points. Within the Configuration view, notes can be taken by the author and discussion between author, co-authors and developer is also allowed.

The user can enter detailed documentation for the software application by selecting the User Guide menu item 256 (see FIG. 6). The information entered via the User Guide menu item 256 becomes part of the Guide for the document 20 and is, thus, accessible from the Guide menu item 44 it FIGS. 1 and 2.

An Index tab 212 provides the tools for creating an index of terminologies used in the document 20. The page numbers associated with a particular term in the index provides navigation link to specific pages within the document 20.

A Preview tab 214 (see FIG. 4) allows the user or others cooperating with the user (e.g., co-authors, publisher, developer) to review the document 20 and provide comments, recommendations for improvement or editorial decisions by using a Discussion tab 226.

A Publish tab 216 can be used in conjunction with the transfer of copyrights to the publisher, developer or other parties. For example, an author can complete a copyright transfer form, which is then submitted to the publisher, developer or other parties.

After the user (i.e., the author) enters the core programming code and other information (e.g., the information for the content and application pages of the document), that information is stored by the authoring system 116. In a typical scenario, a software developer, who has been granted permission by the author to access the information from the system 100, would then be responsible for developing the software to host the required programs. The software host interacts with the cloud computing system 112 to acquire resources, execute applications, save results to the user database 114, and release resources to the cloud computing system 112. The developer also would be responsible for building the application page 24 of the document, which can include developing the graphical user interface and providing the programming code to support the GUI. This programming code would gather user input and submit it to the host for execution. It also may include features such as loading previously executed results from a user database and posting the view state to the view state server for active sharing.

After the developer builds the application including the graphical user interface, the supporting code and the host software, the document 20 with the integrated software application can be hosted, for example, on a server system accessible via the Internet, as in FIG. 3. In some implementations, the document 20 may reside in a user device 102, a local or wide area network (e.g., LAN or WAN) or a cloud system, which can be accessed by an end user device through wired and/or wireless connections.

As mentioned previously, the user interface described above allows the author of a document 20 to grant various permissions to other users. Thus, if another user is granted the required permissions, he can customize an existing document stored by the system 100 for his specific needs. The customization may be as simple as hiding certain parts of the document's content which may not be needed or adding additional static material to the document. The user also can make other changes to the content of the document. One reason for making such changes can be that the user's intentions in using the document may not be completely compatible with the content of the document. Thus, changes can be made to any textual content. For content with an integrated software application, the description or instruction as well as the labels for the data fields can be changed to reflect the changed contents. The user also can incorporate one or more software applications from an existing document into a new document with different content. Thus, the user can create a document that contains new content, but that incorporates a software application from an existing document.

A particular user who has been granted access permissions to modify a document's content may, for example, want to change the content to be in accordance with his or her personal goals. Using the mathematically-oriented example of FIGS. 1-2, a teacher, presenter or lecturer may want to use a modified version of the previously created document 20. For example, a calculus teacher may want to teach her students how to calculate derivatives. Using the previously-created document 20 of FIGS. 1-2 and the system 100, the teacher can accomplish this goal. However, the previously-created document 20 may not contain sufficient examples, and the teacher may want to add her own example. The teacher can add her own example(s) by changing the textual content of the previously-created document 20 while still incorporating the same software application for calculating derivatives. If desired, the teacher also may add her class notes.

A reader can access individual pages of a document 20 through the document's table of contents or by using navigation controls. After subscribing to a published document 20, the subscriber gains access to the individual pages of the original document. Furthermore, each page of the original document 20 can be included, if desired, in pages of the subscriber's own document (e.g., through a <frame> html tag).

In some cases, multiple entities may cooperate together to create or modify a document 20 through the system 100. For example, in a particular scenario, an author of a mathematically-oriented document 20 would provide the algorithm and core programming code for incorporation into a software application by a software developer. The author also would provide the content describing the context that is to accompany the algorithm. The developer would provide the interactive user interface for the document, as well as the presentation of the solution that integrates the core programming code. The software application then is made accessible to the author, who can customize the user interface or presentation of the solution to integrate with the context of the document. The algorithm can be static such that it is not subject to any user modifications. This would ensure that the software application performs the tasks specified by the algorithm created by the author. In other cases, the algorithm can be dynamic such that the core programming code of the software application is modified to reflect changes made in the algorithm. In addition, the description, as well as labels, for the software application also can be modified to reflect the changed algorithm. A mathematically-oriented document can have multiple algorithms and matching software applications for the same or different mathematical problems.

The system 100 can be set up to require user authentication to limit access to particular documents to a specific group of users. In some implementations, users are assigned a reader role or an author role. Such implementations may require that a user register for, or be assigned to, one of the roles. A user having the role of an author has the rights of a user assigned a reader role as well as the ability to modify or create new documents in the system.

A user assigned to a reader role can conduct his own research within the scope of his designated context and can apply the research to various subject fields, can specify the algorithm and the accompanying software application(s), and can modify data fields and settings of the software application(s) to evaluate unique solutions for the context. The solutions can be published as a static document. In FIGS. 1-2, a Report menu item 30 on the right-hand side of the screen provides a tool for the user to author and publish the static document. The user can display and share results with other users, for example, through peer networking tools. As shown in FIGS. 1-2, a Discussion tab near the top of the page provides a peer networking tool for users to discuss the contents of the page; a Discussion menu item 34 on the right-hand side of the screen provides a peer networking tool for users to discuss the document 20.

The identity of an original author of an algorithm or of software applications used by other readers or authors in new publications can be identified automatically to other readers and can be referenced in appendices for the new publications. On the left-hand side of FIGS. 1-2, a drop-down box 36 allows a reader to select the new document as well as any referenced documents.

The ability of a user, who is assigned a reader role, to publish a report or static document can be based on a software tool, which is unrelated to the software application that evaluates an underlying algorithm. This software tool can be accessed by a reader, for example, by clicking on the Report button 30 in the right-hand column of the document 20 (FIGS. 1 and 2). This feature provides a reader with a software tool, like the one in FIG. 5. However, in this implementation, the reader's software tool does not contain certain features (e.g., the Application tab 210 and TOC tab 206) related to the creation of application software, as an author's authoring software tool has. Thus, the reader's software tools provide the reader with the tools necessary for handling a static document.

A user is able to modify an existing document stored by the system by accessing, for example, any given page of the document through a browser. If a content page of the original document is to be modified, the user can copy and paste electronically the text she wants to edit. Alternatively, she can view and save the page's source HTML code through an HTML source code viewer. The user then can edit the saved HTML file using an HTML editor, such as shown in FIG. 5.

A user can create a new document that includes an existing software application integrated with a previously-created document stored by the system by accessing the application page of the original document in the user's own application page. In some situations, the labels as well as the values for the input fields can be modified and then saved. When including the application page of the original document, the saved labels or values in the input fields are used.

Sharing a document can include publishing the document through the system 100 so that other users can access and view the document. Both passive and active sharing are available. Passive sharing means that the document is not presented to other users in real time. Thus, from the point of view of the author of a particular document, the document is shared passively. Such functionality can be implemented, for example, through a user account system. To enhance user experience, a document can embed passive peer networking tools that include, for example, blog or instant messaging in order to encourage other users to ask questions, discuss their findings, exchange new ideas or respond in some other way.

For education purposes, a document 20 can include self-administered quizzes to ensure that the contents of the document are understood. For example, in FIGS. 1-2, a Quiz menu item 38 on the right-hand side provides the reader a Quiz view for self-administered testing. Through passive peer networking, the author or an instructor can also post on-line exams. As an example, the author of the document 20 in FIGS. 1-2 can publish the document the system 100 so that colleagues can access it through their user devices 102. In this case, the author does not present the material in real time. Instead, the document 20 can be accessed and viewed through the system 100 by a particular at her convenience. Thus, sharing documents can be performed in a passive manner.

A document 20 also can be shared with other users in an active manner. For example, the document 20 can be presented at a specific time by a specific person. One technique for providing active sharing is through the use of the Internet in real time. This can be achieved through peer networking technology including server and client embedded systems. Through a client software tool known as Active Adaptive Browser, the presenter's actions, such as navigating to a different page of the document 20 or submitting values for the data fields of a software application for execution, are reflected automatically by the Active Adaptive Browser tool of a member of the audience without that person's intervention. The Active Adaptive Browser tool also allows a member of the audience to navigate through a document being presented without affecting the on-going presentation and without being reflected in other users' Active Adaptive Browser tools. Through the Active Adaptive Browser tool, the presenter can pose questions for the audience or for a specific user in the audience. The presenter can also conduct instant pools or quizzes to gauge whether the material in the presented document 20 is understood.

The Active Adaptive Browser tool also can include audio or video tools to facilitate remote presentation where the presenter is in a physically different location from the users of the audience, who themselves may be in different locations. For example, in a classroom or lecture hall setting, there may be no need for audio or video tools. In the example of FIGS. 1-2, the document 20 is shown in an Active Adaptive Browser tool on a client computer. Near the bottom of the left-hand corner of the screen, a status indicator is “Live” 40 meaning that the document 20 is currently being presented. A reader can click a “Join” button 42 to join the presentation. As the presenter navigates through the document 20 during the presentation, the system 100 records and posts the presenter's view state to a system server. The user device of an audience member checks through the Active Adaptive Brower tool whether the presenter's view state has changed. If has changed, the Active Adaptive Brower tool updates the audience member's user device with the current view of the presenter through the system 100.

As an example, if a school closes because of inclement weather, but a math teacher nevertheless wants to teach students a lesson about derivatives, the teacher can present a document, such as the mathematically-oriented document 20 of FIGS. 1-2, over the Internet. The teacher can present the document 20 in real time in a way that allows him to control the view of the document on the students' user devices.

A document 20 also can include a news feed for the author to make announcements of new improvements or functionality of existing or new documents, to pose schedules of presentations of the document, or rent space for advertisements of services.

An application solution is a software-based system designed for complex tasks (e.g., problem solution, product research and development), which may require multifaceted components that can be implemented by interrelated documents 20 following a specific business logic. Such a system provides tools that integrate individual document solutions following the business logic, such that the collective individual document solutions produce a solution to the task. As mentioned above, for a single document, or multiple documents with related algorithms, multiple software applications can be dependent such that one software application relies not only on user input for data fields, but also on the results of one or more other software applications. Thus, multiple documents 20 can be stacked so that they function to produce a solution to complicated or multi-part problem.

FIG. 11 illustrates an example of a consumer survey software system that incorporates methodologies from multiple documents 20. In the Application view, which can be accessed by selecting an Application tab 320, the left-hand side of the page lists available applications for the project. For example, a Design application 322 provides software tools to calculate a sample size for a survey. A Manual menu item 324 on the right-hand side of the page provides a manual of the software system. The manual is a document including content pages to describe the procedures and details for using the software system and one or more application pages that allow a user to learn the inter-workings of the survey software system. A Presentation menu item 326 provides tools that can be used, for example, for authoring and publishing a presentation for management, team members or customers.

Implementations of the subject matter and the operations described in this specification can include digital electronic circuitry, or computer software, firmware, or hardware, including the structures disclosed in this specification and their structural equivalents, or in combinations of one or more of them. Implementations of the subject matter described in this specification can include one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can include operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus and execution environment can realize various different computing model infrastructures, such as web services, distributed computing, grid computing infrastructures and cloud computing.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for performing actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Although this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described herein and the attachments hereto should not be understood as requiring such separation in all implementations, and it should be understood that the described program components and systems can generally be integrated together in a single software product or packaged into multiple software products.

Thus, although particular implementations of the subject matter have been described, other implementations are within the scope of the claims.

What is claimed is:

1. An apparatus comprising:
an interactive user interface operable to present screens to a user to facilitate creating or modifying an electronic document that comprises one or more content pages and an application page that includes an integrated software application related to content of the content page, the application page of the document presenting a graphical user interface to allow entries to be made in data fields appearing on the application page and to be used as input by the software application, which in response to receiving the input, returns output to be displayed on the application page, the interactive user interface comprising:
a content screen through which the user enters content for each content page of the document; and
an application screen through which the user enters information related to the application page, wherein the application screen is operable to provide a first view for the user to enter information specifying one or more of layout, input control, report control or plot control for the graphical user interface, and a second view for the user to enter core programming code for the software application.

2. The apparatus of claim 1 wherein the application screen is further operable to provide a third view of an XML file that captures results of evaluating the software application.

3. The apparatus of claim 2 wherein the application screen is operable to allow a user to specify that the results of evaluating the software application are to be used as input to another software application to enable connectivity of multiple software applications in the document.

4. The apparatus of claim 1 wherein the interactive user interface is operable to cause information entered by the user through the content screen and the application screen to be stored in a network server system.

5. The apparatus of claim 1 wherein the interactive user interface includes a screen through which the user can enter a table of contents for the document, wherein each page of the document is linked to a corresponding entry in the table of contents.

6. The apparatus of claim 1 wherein the interactive user interface includes a screen through which the user can indicate whether the document is to be a newly created document or a modification of a previously stored document.

7. The apparatus of claim 1 wherein the interactive user interface is operable to permit the user to upload information entered through the content screen and the application screen to a user account associated with the user.

8. The apparatus of claim 1 wherein the interactive user interface includes a screen through which the user establishes access permissions, wherein the access permissions specify which, if any, of the content pages or the application page one or more third parties are permitted to access or modify.

9. The apparatus of claim 1 wherein the interactive user interface includes a screen that provides a peer networking tool for the user to exchange communications with a third party about creation or modification of the document.

10. A system comprising:
a server system operable to provide, to a user device, information to cause interactive screens to be displayed on the user device to facilitate a user's creating or modifying an electronic document that comprises one or more content pages and an application page that includes an integrated software application related to the content of the content page, the application page of the document presenting a graphical user interface to allow entries to be made in data fields appearing on the application page and to be used as input by the software application, which in response to receiving the input, returns output to be displayed on the application page, the interactive screens comprising:
a content screen through which the user enters content for each content page of the document; and
an application screen through which the user enters information related to the application page, wherein the application screen is operable to provide a first view for the user to enter information specifying one or more of layout, input control, report control or plot control for the graphical user interface, and a second view for the user to enter core programming code for the software application,
wherein the server system is operable to store information entered by the user through the content screen and the application screen.

11. The system of claim 10 wherein the document with the integrated software application is stored at its own web site on the Internet, and each page of the document is implemented as a web page.

12. The system of claim 10 wherein the document with the integrated software application is hosted on the server system and is accessible via the Internet.

13. The system of claim 12 wherein the server system comprises a user account system to facilitate sharing of the document with other users.

14. The system of claim 12 wherein the server system is operable to facilitate active sharing of the document through peer networking technology including server and client embedded systems.

15. The system of claim 14 wherein the server system is operable to allow presentation of the document such that a presenter's navigating to a different page of the document or submitting a value for the data fields of the software application for execution is reflected automatically to a member of an audience.

16. The system of claim 15 wherein the server system is operable to allow a member of the audience to navigate through a document being presented without affecting an on-going presentation and without being reflected on other users' devices.

17. The system of claim 10 wherein the interactive screens are operable to allow a user to incorporate one or more software applications from an existing document into a new document with different content.

18. The system of claim 10 wherein the application screens are operable to provide a third view of an XML file that captures results of evaluating the software application.

19. The system of claim 18 wherein the application screen is operable to allow a user to specify that the results of evaluating the software application are to be used as input to another software application to enable connectivity of multiple software applications in the document.

20. The system of claim 10 wherein information entered by the user through the content screen and the application screen to be stored in a network server system.

21. The system of claim 10 wherein the interactive screens include a screen through which the user can enter a table of contents for the document, wherein each page of the document is linked to a corresponding entry in the table of contents.

22. The system of claim 10 wherein the interactive screens include a screen through which the user can indicate whether the document is to be a newly created document or a modification of a previously stored document.

23. The system of claim 10 wherein the interactive screens are operable to permit the user to upload information entered through the content screen and the application screen to a user account associated with the user.

24. The system of claim 10 wherein the interactive screens include a screen through which the user establishes access permissions, wherein the access permissions specify which, if any, of the content pages or the application page one or more third parties are permitted to access or modify.

25. The system of claim 10 wherein the interactive screens include a screen that provides a peer networking tool for the user to exchange communications with a third party about creation or modification of the document.

26. A method for facilitating creation or modification of an electronic document, the method comprising:
using an interactive user interface that presents screens to facilitate creating or modifying an electronic document that comprises one or more content pages and an application page that includes an integrated software application related to the content of the content page, the application page of the document presenting a graphical user interface to allow entries to be made in data fields appearing on the application page and to be used as input by the software application, which in response to receiving the input, returns output to be displayed on the application page;
entering content for each content page of the document through a content screen displayed by the interactive user interface; and
entering information related to the application page through an application screen displayed by the interactive user interface, wherein entering information in the application screen includes:
entering, in a first view of the application screen, information specifying one or more of layout, input control, report control or plot control for the graphical user interface, and
entering, in a second view of the application screen, core programming code for the software application.

27. The method of claim 26 including using the interactive user interface to enter information specifying that the results of evaluating the software application are to be used as input to another software application to enable connectivity of multiple software applications in the document.

28. The method of claim 26 including using the content screen to enter a table of contents for the document, wherein each page of the document is linked to a corresponding entry in the table of contents.

29. The method of claim 26 including using the interactive user interface to indicate whether the document is to be a newly created document or a modification of a previously stored document.

30. The method of claim 26 including submitting a request through the interactive user interface to upload information entered through the content screen and the application screen to a user account associated with the user.

31. The method of claim 26 including using the interactive user interface to establish access permissions, wherein the access permissions specify which, if any, of the content pages or the application page one or more third parties are permitted to access or modify.

32. The method of claim 26 including using the interactive user interface to exchange communications with a third party about creation or modification of the document through a peer networking tool.

33. An article comprising a machine-readable medium storing instructions for facilitating creation or modification of an electronic document, wherein, when executed by a computer system, the instructions cause the computer system to:
present an interactive user interface to facilitate creating or modifying an electronic document that comprises one or more content pages and an application page that includes an integrated software application related to content of the content page, the application page of the document presenting a graphical user interface to allow entries to be made in data fields appearing on the application page and to be used as input by the software application, which in response to receiving the input, returns output to be displayed on the application page, the interactive user interface comprising:
a content screen through which a user enters content for each content page of the document; and
an application screen through which the user enters information related to the application page, wherein the application screen is operable to provide a first view for the user to enter information specifying one or more of layout, input control, report control or plot control for the graphical user interface, and a second view for the user to enter core programming code for the software application.

34. A system comprising:
a server system including one or more servers to manage and host a library of documents that is accessible from a user device via one or more network web sites, wherein each document includes content and an integrated software application, and wherein each software application is operable to receive one or more user-modifiable input values entered in one or more data fields displayed on the user device;
a database to store user data for the software applications; and
a cloud computing platform to perform computations requested by the software applications,
wherein the software applications are operable to provide output based on the received input values for display on the user device.

35. The system of claim 34 including a plurality of user devices coupled to the server system via a computer network, wherein the user devices are operable for actively sharing a particular document from the library such that a first user's actions with respect to the particular document are automatically displayed on respective devices of other users.

36. The system of claim 35 wherein the first user's actions include navigating to a different page of the particular document or submitting for execution values for the data fields of the particular document's software application.

37. The system of claim 35 wherein the devices of the other users are operable to allow a respective user to navigate through a document being presented without affecting an on-going presentation and without being reflected on other users' devices.

38. The system of claim 34 wherein a plurality of the documents are interrelated such that output from the integrated software application of a first one of the documents is provided automatically as input for the integrated software application of a second one of the documents.
